(19) United States
(12) Patent Application Publication
(10) Pub. No.: US 2011/0292023 A1
(43) Pub. Date: Dec. 1, 2011

(54) METHOD OF PROCESSING DATA AND DISPLAY APPARATUS PERFORMING THE METHOD

(75) Inventors: Jong-Hyon PARK, Asan-si (KR); Seok-Hwan ROH, Cheonan-si (KR)

(73) Assignee: SAMSUNG ELECTRONICS CO., LTD., Suwon-si (KR)

(21) Appl. No.: 12/959,573

(22) Filed: Dec. 3, 2010

(30) Foreign Application Priority Data
Jun. 1, 2010 (KR) 2010-0051578

(51) Int. Cl. G09G 5/00; H04N 11/02

(52) U.S. Cl. 345/212; 375/240.16

(57) ABSTRACT

A display apparatus includes a display panel, a data processor, a data driver, and a gate driver. The display panel displays images. The data processor generates at least one interpolated frame data by using a first motion vector calculated by a plurality of frame data, and generates a current frame compensation data by using the current frame data, an adjacent frame data adjacent to the current frame and the interpolated frame data. The data driver outputs a data voltage corresponding to the current frame compensation data to the display panel. The gate driver outputs a gate signal to the display panel in synchronized with an output of the data voltage.

This application claims priority to Korean Patent Application No. 2010-51578, filed on Jun. 1, 2010, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention relate to a method of processing data and a display apparatus for performing the method. More particularly, exemplary embodiments of the present invention relate to a method of processing data displayed on a liquid crystal display (“LCD”) apparatus and a display apparatus for performing the method.

2. Description of the Related Art

Generally, an LCD device includes two substrates disposed substantially opposite to each other and a liquid crystal layer disposed between the substrates. The liquid crystal layer includes liquid crystal molecules having a refractive index Δn. When an electric field is applied to the liquid crystal molecules, an arrangement of the liquid crystal molecules is altered. When the arrangement of the liquid crystal molecule is altered, a transmittance of light therethrough is altered in accordance with the arrangement of liquid crystal molecules so that an image may be displayed.

Since a response speed of liquid crystals is relatively slow, a previous image may be overlaid with a current image to generate display defects such as a blurring effect. In order to improve a response speed of liquid crystals, a dynamic capacitance compensation (referred to as DCC) technology has been developed. In the DCC technology, a current frame data is compensated using a previous frame data to enhance a response speed of liquid crystal molecules. For example, when a data gradation of a current frame is greater than that of a previous frame, the data gradation of the current frame is overdriven to a higher gradation than the data gradation of the current frame would otherwise have in order to enhance a rising response speed of the liquid crystal molecules. When a data gradation of a current frame is smaller than that of a previous frame, the data gradation of the current frame is underdriven to a lower gradation than the data gradation of the current frame would otherwise have to enhance a falling response speed of the liquid crystal molecules. The overdriving and underdriving may both be referred to by the term “overshooting”.

However, as a frame rate of the LCD device is increased from about 60 Hz to about 120 Hz, 240 Hz, etc., the overshooting may be viewed as a display defect and display quality may be decreased.

### BRIEF SUMMARY OF THE INVENTION

Exemplary embodiments of the present invention provide a method of processing data for enhancing display quality.

Exemplary embodiments of the present invention also provide a display apparatus for performing the above-mentioned method.

According to one aspect of the present invention, there is provided an exemplary embodiment of a method of processing data. In the method, a first motion vector is calculated using a plurality of frame data. At least one interpolated frame data corresponding to at least one interpolated frame is generated using the first motion vector. A current frame compensation data is generated using a current frame data, an adjacent frame data of a frame which is adjacent to a current frame in time and the at least one interpolated frame data.

In an exemplary embodiment, the current frame may be an n-th frame, wherein ‘n’ is a natural number, the frame which is adjacent to the current frame in time may be an (n−1)-th frame and the interpolated frame may be an (n−2)-th frame. The first motion vector may be calculated using n-th frame data corresponding to the n-th frame and (n−1)-th frame data corresponding to the (n−1)-th frame.

In an exemplary embodiment, the current frame may be an n-th frame, the adjacent frame may be an (n−1)-th frame, and the interpolated frame may be an (n+1)-th frame. The first motion vector may be calculated using the n-th frame data and the (n−1)-th frame data.

In an exemplary embodiment, the current frame may be an n-th frame, the adjacent frame may be an (n−1)-th frame, and the interpolated frame may be an (n−2)-th frame. In such an exemplary embodiment, a second motion vector may be calculated using the (n−1)-th frame data and an (n−3)-th frame data interpolated using the first motion vector. The (n−1)-th frame data and the (n−3)-th frame data interpolated may be generated using the second motion vector. In such an exemplary embodiment, the current frame compensation data may be generated using the n-th frame data, the (n−1)-th frame data, (n−2)-th frame data and the (n−3)-th frame data.

According to another aspect of the present invention, an exemplary embodiment of a display apparatus includes a display panel, a data processor, a data driver, and a gate driver. The display panel displays images. The data processor generates at least one interpolated frame data using a first motion vector calculated by a plurality of frame data, and generates a current frame compensation data using the current frame data, an adjacent frame data adjacent to the current frame and the interpolated frame data. The data driver outputs a data voltage corresponding to the current frame compensation data to the display panel. The gate driver outputs a gate signal to the display panel in synchronization with an output of the data voltage.

In an exemplary embodiment, the data processor may include a motion estimating-interpolating part and a data compensating part. The motion estimating-interpolating part may calculate the first motion vector and generate the interpolated frame data. The data compensating part may generate a current frame compensation data by using a current frame data, an adjacent frame data adjacent to the current frame and the interpolated frame data.

According to an exemplary embodiment of a method of processing data and a display apparatus for performing the method, a compensation frame data for an n-th frame is generated in consideration with a variation of at least three frame data, so that display quality of a display apparatus may be enhanced. Moreover, the calculated motion vectors are used when an (n−1)-th frame data is generated, so that motion estimating error may be decreased.

### BRIEF DESCRIPTION OF THE DRAWINGS

The above and other features and advantages of the present invention will become more apparent by describing in detailed example embodiments thereof with reference to the accompanying drawings, in which:

FIG. 1 is a block diagram illustrating an exemplary embodiment of a display apparatus according to the present invention;

FIG. 2 is a block diagram illustrating a data processor of FIG. 1;

FIG. 3 is a concept diagram illustrating a motion estimating and interpolating method of a motion estimating-interpolating part of FIG. 2;

FIG. 4 is a concept diagram illustrating a data compensation method of a data processor of FIG. 2;

FIG. 5 is a flowchart showing a driving method of a data processor of FIG. 1;

FIG. 6 is a block diagram illustrating another exemplary embodiment of a data processor according to the present invention;

FIG. 7 is a flowchart illustrating a driving method of a data processor of FIG. 6;

FIG. 8 is a block diagram illustrating another exemplary embodiment of a data processor according to the present invention;

FIGS. 9A, 9B and 9C are concept diagrams illustrating a motion estimating and interpolating method of a motion estimating-interpolating part of FIG. 8;

FIG. 10 is a flowchart showing a driving method of a data processor of FIG. 9;

FIG. 11 is a block diagram illustrating another exemplary embodiment of a data processor according to the present invention;

FIG. 12 is a concept diagram illustrating a data compensation method of a data processor of FIG. 11;

FIG. 13 is a flowchart showing a driving method of a data processor of FIG. 11;

FIG. 14A is a graph showing response characteristics of liquid crystal molecules due to a data compensation structure of a comparative embodiment; and

FIG. 14B is a graph showing response characteristics of liquid crystal molecules due to an exemplary embodiment of a data compensation structure of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element's as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

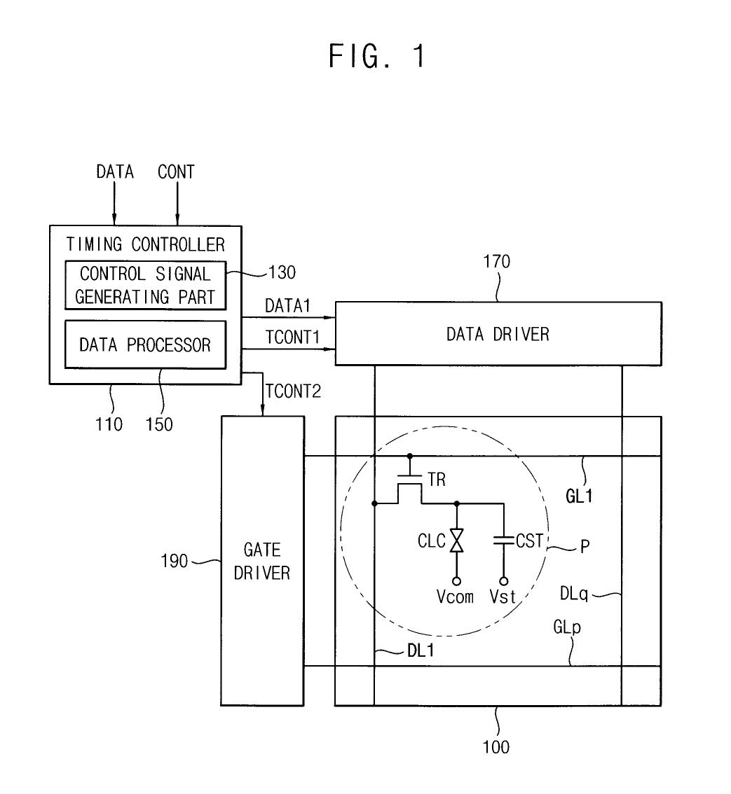

FIG. 1 is a block diagram illustrating an exemplary embodiment of a display apparatus according to the present invention.

Referring to FIG. 1, the present exemplary embodiment of a display apparatus includes a display panel 100, a timing controller 110, a data driver 170 and a gate driver 190.

The display panel 100 includes a plurality of gate lines GL1 to GLp, a plurality of data lines DL1 to DLq and a plurality of pixels P. In the present exemplary embodiment, “p” and “q” are natural numbers. Each of the pixels P includes a driving element TR, a liquid crystal capacitor CLC electrically connected to the driving element TR and a storage capacitor CST electrically connected to the driving element TR. The display panel 100 may include two substrates disposed substantially opposite to each other and a liquid crystal layer disposed between the two substrates.

The timing controller 110 may include a control signal generating part 130 and a data processor 150.

The control signal generating part 130 generates a first timing control signal TCON1 for controlling a driving timing of the data driver 170 based on a control signal CON received from an external device (not shown) and a second timing control signal TCON2 for controlling a driving timing of the gate driver 190. The first timing control signal TCON1 may include a horizontal start signal, a polarity control signal, an output enable signal, and various other similar signals. The second timing control signal TCON2 may include a vertical start signal, a gate clock signal, an output enable signal, and various other similar signals.

The data processor 150 calculates a first motion vector using a plurality of frame data, and generates at least one interpolated frame data interpolated using the first motion vector. The data processor 150 generates a current frame compensation data using a current frame data, an adjacent frame data adjacent to the current frame and the interpolated frame data in time. For example, when the current frame is an n-th frame, wherein ‘n’ is a natural number, the adjacent frame may be an (n−1)-th frame, and the interpolated frame may be an (n−2) frame.

The data driver 170 converts a current frame compensation data received from the data processor 150 into an analog type data voltage. The data driver 170 outputs the data voltage to the data lines DL1 to DLq.

The gate driver 190 outputs a plurality of gate signals to the gate lines GL1 to GLp in synchronization with an output of the data driver 170.

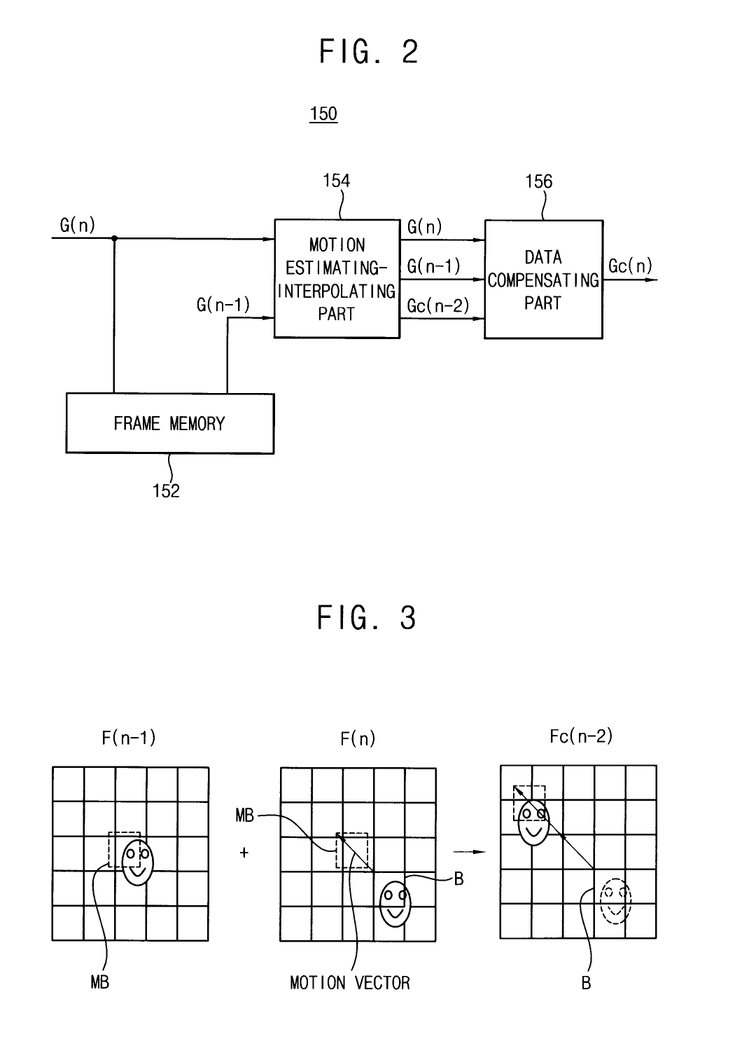

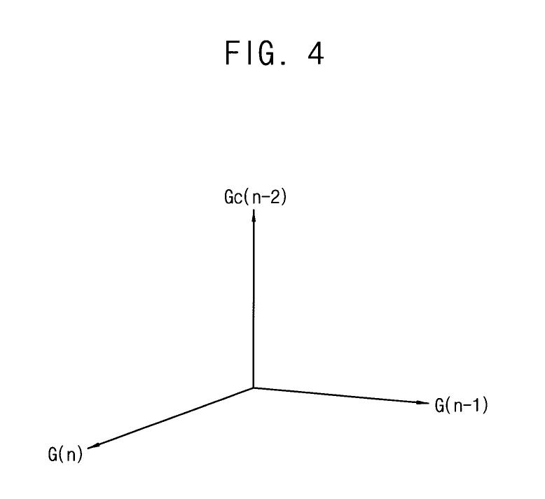

FIG. 2 is a block diagram illustrating an exemplary embodiment of a data processor of FIG. 1. FIG. 3 is a concept diagram illustrating a motion estimating and interpolating method of a motion estimating-interpolating part of FIG. 2. FIG. 4 is a concept diagram illustrating a data compensation method of a data processor of FIG. 2.

Referring to FIGS. 1 and 2, the data processor 150 includes a frame memory 152, a motion estimating-interpolating part 154 and a data compensating part 156.

The frame memory 152 stores a data input from an external device (not shown) in a frame unit thereof. The frame memory 152 outputs an (n−1)-th frame data G(n−1) in response to an input of the n-th frame data G(n). The (n−1)-th frame data G(n−1) is applied to the motion estimating-interpolating part 154.

The motion estimating-interpolating part 154 receives the n-th frame data G(n) input from an external device (not shown) and the (n−1)-th frame data G(n−1) input from the frame memory 152. The motion estimating-interpolating part 154 calculates a motion vector using the n-th frame data G(n) and the (n−1)-th frame data G(n−1). For example, the motion estimating-interpolating part 154 may estimate a motion in a block unit using a block matching algorithm (“BMA”) as known to one of ordinary skill in the art.

For example, as shown in FIG. 3, the motion estimating-interpolating part 154 divides the n-th frame F(n) into a plurality of blocks. The motion estimating-interpolating part 154 calculates a motion vector for each block of the n-th frame F(n) using an (n−1)-th frame F(n−1). For example, the motion estimating-interpolating part 154 searches for a most similar block MB (hereinafter, a matching block) which is most similar with a block B (hereinafter, a current block) corresponding to an object OB of the n-th frame F(n) at the (n−1)-th frame F(n−1). The motion estimating-interpolating part 154 may search for a block which minimizes a difference between the current block B and a luminance at the (n−1)-th frame F(n−1) and determine the searched for block to be the matching block MB. A position difference between the current block B and the luminance thereof may be the motion vector ‘v’ for the current block ‘B’. The motion estimating-interpolating part 154 may calculate the motion vector for the current block ‘B’ using motion vectors for blocks which are peripheral to the current block ‘B’.

The motion estimating-interpolating part 154 may estimate a motion of a pixel unit using a pixel recursive algorithm (“PRA”) as known to one of ordinary skill in the art.

The motion estimating-interpolating part 154 generates an interpolated (n−2)-th frame data Gc(n−2) by interpolating the n-th frame data G(n), or the (n−1)-th frame data G(n−1), using the motion vector. For example, the motion estimating-interpolating part 154 may shift the n-th frame data G(n) by two times a magnitude of the motion vector along a direction substantially identical to a direction of the motion vector to generate the interpolated (n−2)-th frame data Gc(n−2). Moreover, the motion estimating-interpolating part 154 may shift the (n−1)-th frame data G(n−1) by the motion vector along a direction substantially identical to a direction of the motion vector to generate the interpolated (n−2)-th frame data Gc(n−2).

The motion estimating-interpolating part 154 outputs the n-th frame data G(n), the (n−1)-th frame data G(n−1) and the interpolated (n−2)-th frame data Gc(n−2) to the data compensating part 156.

The data compensating part 156 generates an n-th frame compensation data Gc(n) using the n-th frame data G(n), the (n−1)-th frame data G(n−1) and the interpolated (n−2)-th frame data Gc(n−2).

In one exemplary embodiment, the data compensating part 156 generates the n-th frame compensation data Gc(n) using a three-dimensional look-up table (“LUT”) on which compensation data corresponding to the n-th frame data G(n), the (n−1)-th frame data G(n−1) and the interpolated (n−2)-th frame data Gc(n−2) are mapped. In such an exemplary embodiment, the n-th frame compensation data Gc(n) may have a gradation that is higher than or equal to the n-th frame data G(n). When there is no variation between the n-th frame data G(n) and the (n−1)-th frame data or between the (n−1)-th frame data and the interpolated (n−2)-th frame data, the n-th frame compensation data Gc(n) is substantially equal to the n-th frame data G(n). In such an exemplary embodiment, the data compensating operation may be omitted.

Although not shown, in one exemplary embodiment the motion estimating-interpolating part 154 may generate an interpolated (n−3)-th frame data or previous frame data, e.g., an (n−x)-th frame data where “x” is larger than 3, using the n-th frame data G(n) and the motion vector. In such an exemplary embodiment, the data compensating part 156 may generate the n-th frame compensation data Gc(n) using a four-dimensional (“4D”) LUT on which compensation data corresponding to the n-th frame data G(n), the (n−1)-th frame data G(n−1), the interpolated (n−2)-th frame data Gc(n−1) and the interpolated (n−3)-th frame data Gc(n−3) are mapped.

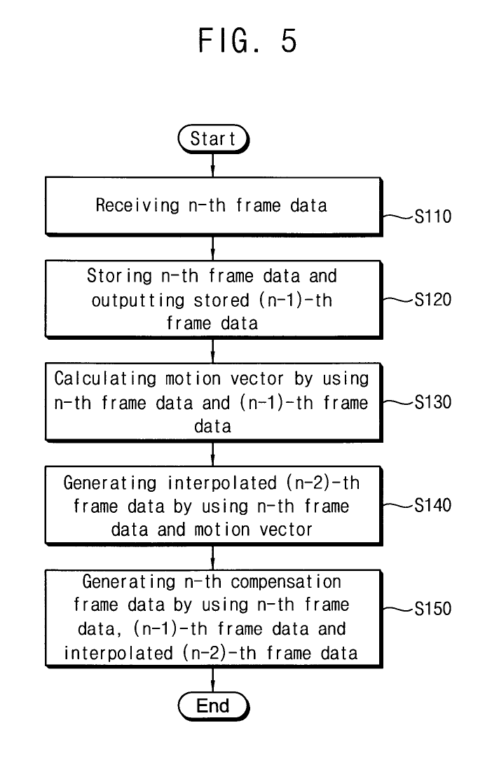

FIG. 5 is a flowchart showing an exemplary embodiment of a driving method of a data processor of FIG. 1.

Referring to FIGS. 2 and 5, when it is determined that the n-th frame data G(n) is received from an external device (step S110), the frame memory 152 stores the n-th frame data G(n) and outputs the (n−1)-th frame data G(n−1) stored thereon to the motion estimating-interpolating part 154 (step S120).

The motion estimating-interpolating part 154 calculates the motion vector using the n-th frame data G(n) input from the external device and the (n−1)-th frame data G(n−1) input from the frame memory 152 (step S130).

The motion estimating-interpolating part 154 generates an interpolated (n−2)-th frame data Gc(n−2) by interpolating the n-th frame data G(n) using the motion vector (step S140).

The data compensating part 156 generates the n-th frame compensation data Gc(n) using the n-th frame data G(n), the (n−1)-th frame data G(n−1) and the interpolated (n−2)-th frame data Gc(n−2) (step S150).

Although not shown in FIGS. 2 and 5, in one exemplary embodiment the motion estimating-interpolating part 154 interpolates the (n−1)-th frame data G(n−1) using the motion vector to generate the interpolated (n−3)-th frame data Gc(n−3). In such an exemplary embodiment, the data compensating part 156 generates the n-th frame compensation data Gc(n) using the n-th frame data G(n), the (n−1)-th frame data G(n−1), the interpolated frame data Gc(n−2) and the interpolated (n−3)-th frame data Gc(n−3).

According to the present exemplary embodiment, a current frame data is compensated using two frame data adjacent to the current frame, so that generation of an overshooting driving voltage may be reduced.

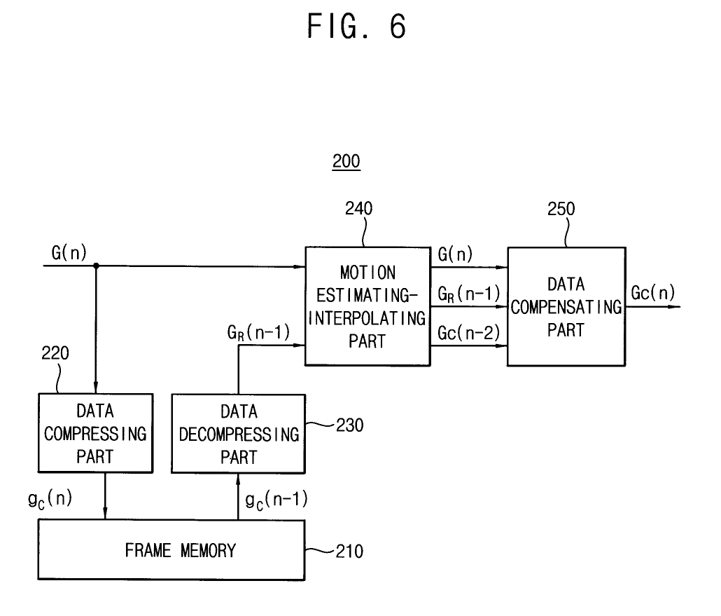

FIG. 6 is a block diagram illustrating another exemplary embodiment of a data processor according to the present invention. The present exemplary embodiment of a display apparatus is substantially similar to the display apparatus of FIG. 1 except for a data processor 200, so that description of the remaining elements except for the data processor 200 may hereinafter be omitted.

Referring to FIGS. 1 and 6, the data processor 200 includes a frame memory 210, a data compressing part 220, a data decompressing part 230, a motion estimating-interpolating part 240 and a data compensating part 250.

The frame memory 210 stores data input from an external device (not shown) in a frame unit thereof.

The data compressing part 220 compresses an n-th frame data G(n) input from the external device to output the n-th frame compressed data gc(n) to the frame memory 210. The n-th frame compressed data gc(n) is then stored in the frame memory 210.

The data decompressing part 230 decompresses the (n−1)-th frame compressed data gc(n−1) from the frame memory 210 to output a decompressed data to the motion estimating-interpolating part 240.

The motion estimating-interpolating part 240 calculates a motion vector using the n-th frame data G(n) input from an external device (not shown) and the (n−1)-th frame decompressed data GR(n−1) input from the data decompressing part 230. The motion estimating-interpolating part 240 may calculate the motion vector using the BMA or the PRA methods as described above. The motion estimating-interpolating part 240 interpolates the n-th frame image data G(n) or the (n−1)-th frame decompressed data GR(n−1) using the motion vector to generate an (n−2)-th frame interpolated data Gc(n−2).

The motion estimating-interpolating part 240 outputs the n-th frame data G(n), the decompressed (n−1)-th frame data GR(n−1) and the (n−2)-th frame data G(n−2) to the data compensating part 250.

Exemplary embodiments include configurations wherein data loss may be generated in the decompressed (n−1)-th frame data GR(n−1) in accordance with a compression mode used by the data compressing part 220. In such exemplary embodiments, the motion estimating-interpolating part 240 may interpolate the n-th frame data G(n) using the motion vector to generate an interpolated (n−1)-th frame data Gc(n−1). For example, in one exemplary embodiment the motion estimating-interpolating part 240 may shift the n-th frame data G(n) by the magnitude of the motion vector along a direction substantially identical to a direction of the motion vector to generate the interpolated (n−1)-th frame data Gc(n−1). The motion estimating-interpolating part 240 outputs the interpolated (n−1)-th frame data Gc(n−1) instead of the decompressed (n−1)-th frame data GR(n−1) to the data compressing part 250.

The data compressing part 250 generates the n-th frame compensation data Gc(n) using the n-th frame data G(n), the decompressed (n−1)-th frame data GR(n−1) and the interpolated (n−2)-th frame data Gc(n−2). The data compensating part 250 may generate the n-th frame compensation data Gc(n) using a three-dimensional (“3D”) LUT on which compensation data corresponding to the n-th frame data G(n), the decompressed (n−1)-th frame data GR(n−1) and the interpolated (n−2)-th frame data Gc(n−2) are mapped.

Moreover, the data compensating part 250 may generate the n-th frame compensation data Gc(n) using the n-th frame data G(n), the interpolated (n−1)-th frame data G(n−1) and the interpolated frame data G(n−2).

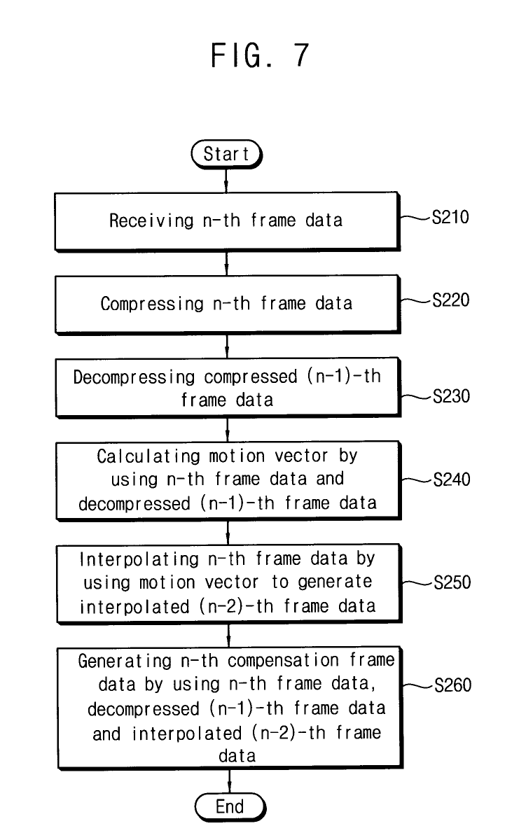

FIG. 7 is a flowchart showing an exemplary embodiment of a driving method of a data processor of FIG. 6.

Referring to FIGS. 6 and 7, when it is determined that the n-th frame data G(n) is received from an external device (step S210), the data compressing part 220 compresses the n-th frame data G(n) (step S220). The n-th frame data gc(n) compressed by the data compressing part 220 is then stored in the frame memory 210.

The data decompressing part 230 decompresses a compressed (n−1)-th frame data gc(n−1) received from the frame memory 210 (step S230). The decompressed (n−1)-th frame data GR(n−1) is provided to the motion estimating-interpolating part 310.

The motion estimating-interpolating part 310 calculates the motion vector using the n-th frame data G(n) and the decompressed (n−1)-th frame data GR(n−1) input from the data decompressing part 230 (step S240).

The motion estimating-interpolating part 240 interpolates the n-th frame data G(n) using the motion vector to generate the interpolated (n−2)-th frame data Gc(n−2) (step S250).

The data compensating part 320 generates the n-th frame compensation data Gc(n) using the n-th frame data G(n), the decompressed (n−1)-th frame data GR(n−1) and the interpolated (n−2)-th frame data Gc(n−2) (step S260).

According to the present exemplary embodiment, data stored in the frame memory 210 is compressed through the data compressing part 220, so that the size of the frame memory 210 may be reduced as compared with a frame memory which does not use a compression algorithm. Moreover, the n-th frame data G(n) is interpolated using the motion vector to generate the interpolated (n−1)-th frame data Gc(n−1), so that compression error generated by the data compression may be prevented from affecting the n-th frame compensation data Gc(n).

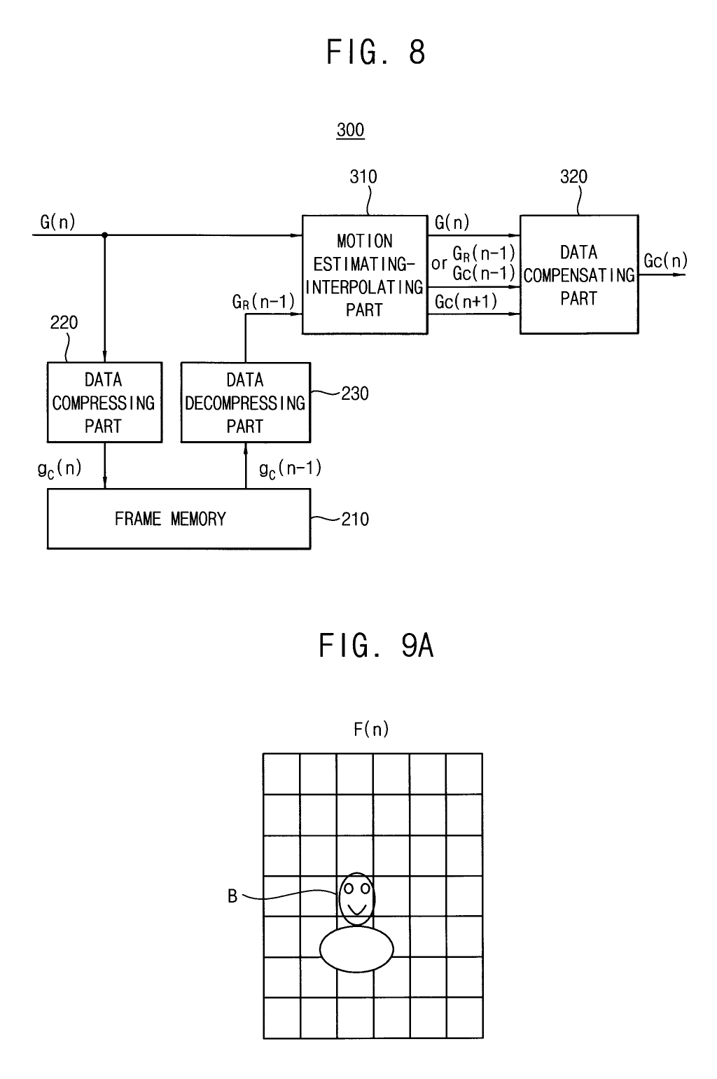

FIG. 8 is a block diagram illustrating another exemplary embodiment of a data processor according to the present invention.

The present exemplary embodiment display apparatus is substantially the same as the display apparatus of FIG. 1 except for a data processor 300, so that description of the remaining elements except for the data processor 300 may hereinafter be omitted. Moreover, the present exemplary embodiment of a data processor 300 is substantially the same as the data processor 200 of FIG. 6 except for a motion estimating-interpolating part 310 and a data compensating part 320, so that description of the remaining elements except for the motion estimating-interpolating part 310 and the data compensating part 320 may hereinafter be omitted.

Referring to FIGS. 1 and 8, the data processor 300 includes a frame memory 210, a data compressing part 220, a data decompressing part 230, a motion estimating-interpolating part 310 and a data compensating part 320.

The motion estimating-interpolating part 310 calculates a motion vector using the n-th frame data G(n) applied from an external device (not shown) and a decompressed (n−1)-th frame data GR(n−1) decompressed by the data decompressing part 230. The motion estimating-interpolating part 310 interpolates the n-th frame data G(n) using the motion vector to generate an interpolated (n+1)-th frame data Gc(n+1).

The motion estimating-interpolating part 310 may interpolate the n-th frame data G(n) using the motion vector to generate an interpolated (n−1)-th frame data Gc(n−1). Moreover, the motion estimating-interpolating part 310 may interpolate the n-th frame data G(n) using the motion vectors to generate the interpolated (n+1)-th frame data Gc(n+1).

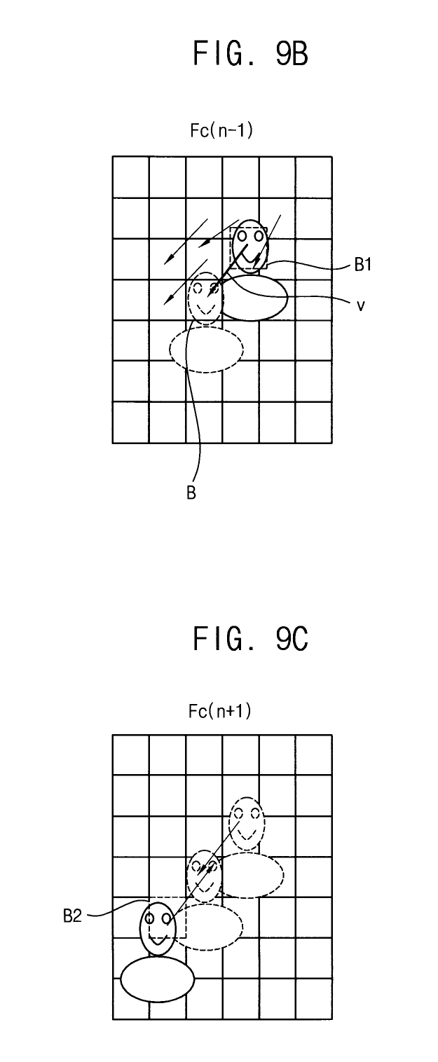

FIGS. 9A, 9B and 9C are concept diagrams illustrating an exemplary embodiment of a motion estimating and interpolating method of a motion estimating-interpolating part of FIG. 8.

FIG. 9A is a concept diagram showing an n-th frame F(n), FIG. 9B is a concept diagram showing an interpolated (n−1)-th frame Fc(n−1) interpolated by the motion estimating-interpolating part 310, and FIG. 9C is a concept diagram showing an interpolated (n−1)-th frame Fc(n−2) interpolated by the motion estimating-interpolating part 310.

Referring to FIGS. 9A to 9C, the motion estimating-interpolating part 310 calculates a motion vector of a current block B of the n-th frame F(n). The motion estimating-interpolating part 310 may calculate a motion vector of the current block B by using peripheral blocks of the current block B, e.g., blocks which are adjacent to the current block B, at the n-th frame F(n). As shown in FIG. 9B, the motion estimating-interpolating part 310 may estimate a position of a block B1 corresponding to the current block B at the interpolated (n−1)-th frame Fc(n−1) using the motion vector ‘v’ of the current block ‘B’.

Moreover, as shown in FIG. 9C, the motion estimating-interpolating part 310 may estimate a position of a block B2 corresponding to the current block B at the interpolated (n+1)-th frame Fc(n+1) using the motion vector ‘v’ of the current block ‘B’. That is, when a direction of the motion vector ‘v’ of the current block ‘B’ is converted into an opposite direction, the previous position of the block ‘B’ may be estimated.

The data compensating part 320 may generate the n-th frame compensation data Gc(n) using the n-th frame data G(n), the decompressed (n+1)-th frame data GR(n−1) and the interpolated (n+1)-th frame data Gc(n+1). Moreover, the data compensating part 320 may generate the n-th frame compensation data Gc(n) using the n-th frame data G(n), the interpolated (n−1)-th frame data Gc(n−1) and the interpolated (n+1)-th frame data Gc(n+1).

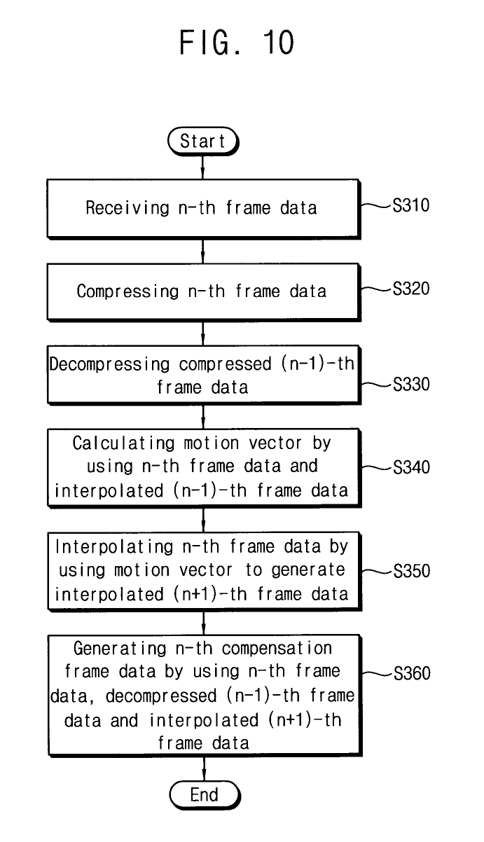

FIG. 10 is a flowchart showing an exemplary embodiment of a driving method of a data processor of FIG. 9.

Referring to FIGS. 8 and 10, when it is determined that the n-th frame data G(n) is received from an external device (step S310), the data compressing part 220 compresses the n-th frame data G(n) (step S320). The n-th frame data gc(n) compressed by the data compressing part 220 is stored in the frame memory 210.

The data decompressing part 230 decompresses a compressed (n−1)-th frame data gc(n−1) inputted from the frame memory 210 (step S330).

The motion estimating-interpolating part 310 calculates the motion vector using the n-th frame data G(n) received from the external device (not shown) and the decompressed (n−1)-th frame data GR(n−1) input from the data decompressing part 230 (step S340).

The motion estimating-interpolating part 310 interpolates the n-th frame data G(n) using the motion vector to generate the interpolated (n+1)-th frame data Gc(n+1) (step S350).

The data compensating part 320 generates the n-th frame compensation data Gc(n) using the n-th frame data G(n), the decompressed (n−1)-th frame data GR(n−1) and the interpolated (n+1)-th frame data Gc(n+1) (step S360).

According to the present exemplary embodiment, the n-th frame compensation data Gc(n) is generated using an (n+1)-th frame data G(n+1) for the n-th frame data G(n), so that a pretilt angle of a liquid crystal molecule may be controlled so that a response speed of the liquid crystal molecules may be enhanced.

In one alternative exemplary embodiment, the data compressing part 220 and the data decompressing part 230 may be omitted from the data processor 300. In such an alternative exemplary embodiment compression errors due to the data compression may be reduced.

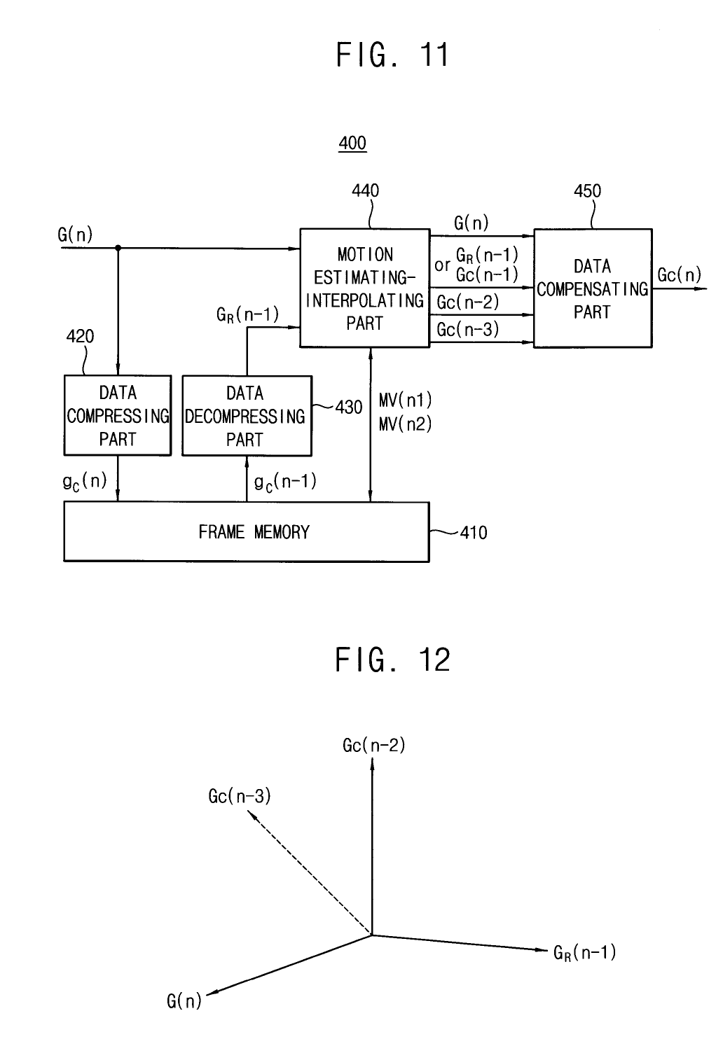

FIG. 11 is a block diagram illustrating another exemplary embodiment of a data processor according to the present invention. FIG. 12 is a concept diagram illustrating an exemplary embodiment of a data compensation method of a data processor of FIG. 11.

The present exemplary embodiment of a display apparatus is substantially the same as the display apparatus of FIG. 1 except for a data processor 400, so that description of the remaining elements except for the data processor 400 may hereinafter be omitted.

Referring to FIGS. 1 and 11, the data processor 400 includes a frame memory 410, a data compressing part 420, a data decompressing part 430, a motion estimating-interpolating part 440 and a data compensating part 540.

The frame memory 410 stores an image data received from an external device (not shown) in a frame unit. Moreover, the frame memory 410 stores a first motion vector MV1 and a second motion vector MV2 calculated by the motion estimating-interpolating part 440.

The data compressing part 420 compresses an n-th frame data G(n) input from an external device to output the frame memory 410. The n-th frame data gc(n) compressed by the data decompressing part 420 is stored in the frame memory 410.

The data decompressing part 430 decompresses a compressed (n−1)-th frame data gc(n−1) input from the frame memory 410 to output the decompressed (n−1)-th frame data GR(n−1) to the motion estimating-interpolating part 440.

The motion estimating-interpolating part 440 generates an interpolated (n−2)-th frame data Gc(n−2) using the decompressed (n−1)-th frame data GR(n−1) received from the data decompressing part 430 and the first motion vector MV1 received from the frame memory 410 in response to the n-th frame data G(n). The first motion vector MV1 is calculated using the (n−2)-th frame data G(n−2) and a decompressed (n−3)-th frame data GR(n−3) decompressed at the data decompressing part 430 at a time when a current frame is an (n−2)-th frame.

The motion estimating-interpolating part 440 generates an interpolated (n−3)-th frame data Gc(n−3) using the decompressed (n−1)-th frame data GR(n−1) and the second motion vector MV2 received from the frame memory 410 in response to the n-th frame data G(n). The second motion vector MV2 is calculated using the (n−1)-th frame data G(n−1) and an interpolated (n−3)-th frame data Gc(n−3) interpolated using the first motion vector MV1 at a time when a current frame is an (n−1)-th frame.

The motion estimating-interpolating part 440 may interpolate the n-th frame data G(n) using the first and second motion vectors MV1 and MV2 to generate an interpolated (n−1)-th frame data Gc(n−1).

The data compensating part 540 may generate an n-th frame compensation data Gc(n) using the n-th frame data G(n), the decompressed (n−1)-th frame data GR(n−1), the interpolated (n−2)-th frame data Gc(n−2) and the interpolated (n−3)-th frame data Gc(n−3).

The data compensating part 540 may generate the n-th frame compensation data Gc(n) using a 4D LUT on which compensation data corresponding to the n-th frame data G(n), the decompressed (n−1)-th frame data GR(n−1), the interpolated (n−2)-th frame data Gc(n−2) and the interpolated (n−3)-th frame data Gc(n−3) are mapped.

Moreover, the data compensating part 540 may generate an n-th frame compensation data Gc(n) using the n-th frame data G(n), the interpolated (n−1)-th frame data Gc(n−1), the interpolated (n−2)-th frame data Gc(n−2) and the interpolated (n−3)-th frame data Gc(n−3).

Although not shown, in one exemplary embodiment the motion estimating-interpolating part 440 may further generate an interpolated (n−4)-th frame data G(n−4) using the first and second motion vectors MV1 and MV2 stored in the frame memory 410. In such an exemplary embodiment, the data compensating part 540 may generate the n-th frame compensation data Gc(n) using a five-dimensional (“5D”) LUT on which compensation data corresponding to five frame data are mapped.

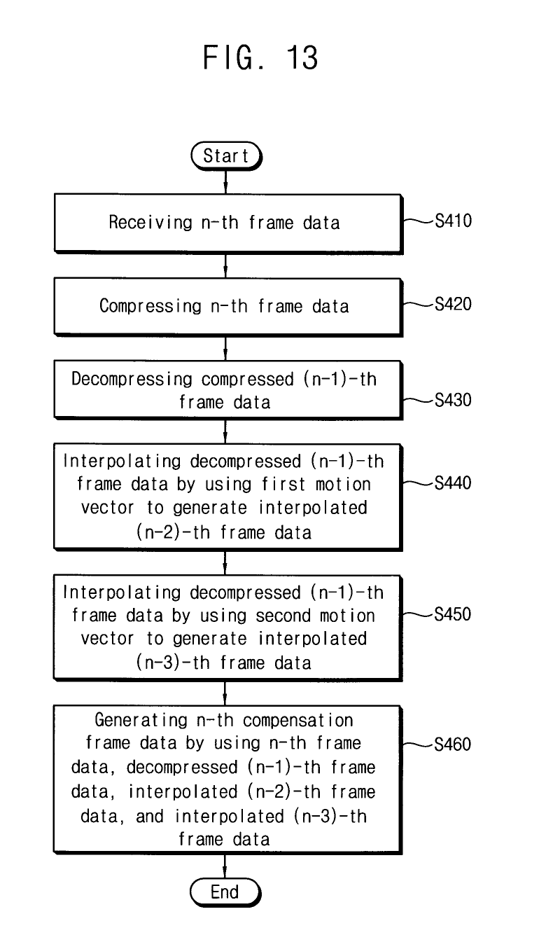

FIG. 13 is a flowchart showing a driving method of a data processor of FIG. 11.

Referring to FIGS. 11 and 13, when it is checked that the n-th frame data G(n) is received from an external device (step S310), the data compressing part 420 compresses the n-th frame data G(n) (step S320). The n-th frame compressed data gc(n) compressed by the data compressing part 420 is stored in the frame memory 410.

The data decompressing part 430 decompresses the compressed n-th frame data gc(n) received from the frame memory 410 to output a decompressed data to the motion estimating-interpolating part 330 (step S330).

The motion estimating-interpolating part 440 interpolates the decompressed (n−1)-th frame data GR(n−1) using the first motion vector MV1 stored in the frame memory 410 to generate the interpolated (n−2)-th frame data Gc(n−2). The interpolated (n−2)-th frame data Gc(n−2) is provided to the data compensating part 450.

The motion estimating-interpolating part 440 interpolates the decompressed (n−1)-th frame data GR(n−1) using the second motion vector stored in the frame memory 410 to generate the interpolated (n−3)-th frame data Gc(n−3). The interpolated (n−3)-th frame data Gc(n−3) is provided to the data compensating part 450.

The data compensating part 540 generates the n-th frame compensation data Gc(n) using the n-th frame data G(n), the decompressed (n−1)-th frame data GR(n−1), the interpolated (n−2)-th frame data Gc(n−2) and the interpolated (n−3)-th frame data Gc(n−3). The n-th frame compensation data Gc(n) is provided to the data driver 170 in order to display an image (refer to FIG. 1).

Although not shown, alternative exemplary embodiments include configurations wherein the data compressing part 420 and the data decompressing part 430 may be omitted from the data processor 400. In such an alternative exemplary embodiment, an operation generating the interpolated (n−1)-th frame data Gc(n−1) may be omitted in the motion estimating-interpolating part 440. Thus, compression error according to the data compression may be reduced.

### <Test of Liquid Crystal Response Characteristics>

A sample display apparatus in which an exemplary embodiment of a data processor according to the present invention is adopted was manufactured, the sample display apparatus was driven in accordance with a frame rate of about 120 Hz, and then luminance variation was measured when a previous before frame data F(n−2), a previous frame data F(n−1) and a current frame data F(n) are at about 255-gradation, about 0-gradation and about 176-gradation, respectively.

A comparative embodiment of a sample display apparatus in which a data processor according to a comparative embodiment is adopted was manufactured, the comparative sample display apparatus was driven in accordance with a frame rate of about 120 Hz, and then luminance variation was measured when an (n−2)-th frame data F(n−2), an (n−1)-th frame data F(n−1) and an n-th frame data F(n) are at about 255-gradation, about 0-gradation and about 176-gradation, respectively.

The data processor according to the comparative embodiment is similar to the previously described exemplary embodiments with the exception that the comparative embodiment has a structure in which the motion estimating-interpolating part 154 is removed from the data processor 150 of the exemplary embodiment of FIG. 2. The comparative embodiment of a data compensating structure has a structure in which the n-th frame data G(n) is compensated using the n-th frame data G(n) and the (n−1)-th frame data G(n−1).

In contrast, the exemplary embodiment of a data compensating structure according to the present invention has a structure in which the n-th frame data G(n) is compensated using the n-th frame data G(n), the (n−1)-th frame data G(n−1) and the (n−2)-th frame data G(n−2).

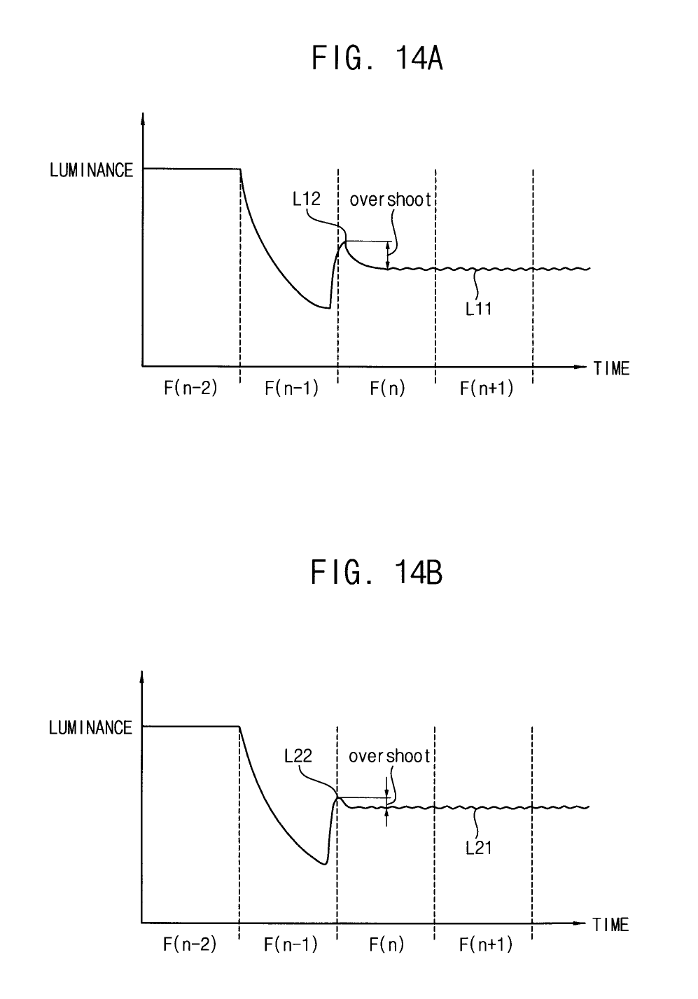

FIG. 14A is a graph showing response characteristics of liquid crystal molecules due to a comparative embodiment of a data compensation structure. FIG. 14B is a graph showing response characteristics of liquid crystal molecules due to an exemplary embodiment of a data compensation structure of the present invention.

As shown in FIG. 14A, according to the comparative embodiment of a data compensation structure, it is recognized that an over luminance L12 over a target luminance L11 is generated due to an overshooting at an (n−1)-th frame F(n−1).

In contrast, as shown in FIG. 14B, according to a data compensation structure of an exemplary embodiment of the present invention, it is recognized that a substantially identical luminance, in the present exemplary embodiment an identical luminance L22 identical to the target luminance L21, is generated due to a decrease of an overshooting amount at an n-th frame F(n). That is, according to the data compensation structure of an exemplary embodiment of the present invention, it is recognized that a stable response may be obtained without unnecessary overdriving.

As described above, according to exemplary embodiments of the present invention, an n-th frame compensation data is generated in consideration with an (n−2)-th frame data or a further frame data (i.e., an (n+1)-th frame data, an (n+2)-th frame data, etc.) as well as an (n−1)-th frame data for an n-th frame data, so that a generation of an overshooting may be reduced so that display defects may be prevented. Thus, display quality of a display apparatus may be enhanced.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of processing data, the method comprising:
calculating a first motion vector using a plurality of frame data;
generating at least one interpolated frame data corresponding to at least one interpolated frame using the first motion vector; and
generating a current frame compensation data using a current frame data, an adjacent frame data of a frame which is adjacent to a current frame in time and the at least one interpolated frame data.

2. The method of claim 1, wherein the current frame is an n-th frame, wherein ‘n’ is a natural number, the frame which is adjacent to the current frame in time includes an (n−1)-th frame and the interpolated frame is an (n−2)-th frame, and
the first motion vector is calculated using n-th frame data corresponding to the n-th frame and (n−1)-th frame data corresponding to the (n−1)-th frame.

3. The method of claim 2, further comprising:
compressing the n-th frame data; and
decompressing a compressed (n−1)-th frame data.

4. The method of claim 3, further comprising:
generating an interpolated (n−1)-th frame data using the n-th frame data,
wherein the current frame compensation data is generated using the n-th frame data, the interpolated (n−1)-th frame data and an interpolated (n−2)-th frame data.

5. The method of claim 1, wherein the current frame is an n-th frame, wherein ‘n’ is a natural number, the frame which is adjacent to the current frame in time includes an (n−1)-th frame, and the at least one interpolated frame includes an (n+1)-th frame, and
the first motion vector is calculated using n-th frame data corresponding to the n-th frame and (n−1)-th frame data corresponding to the (n−1)-th frame.

6. The method of claim 5, further comprising:
compressing the n-th frame data; and
decompressing an (n−1)-th frame compressed data.

7. The method of claim 6, further comprising generating an interpolated (n−1)-th frame data using the n-th frame data,
wherein the current frame compensation data is generated using the n-th frame data, an interpolated (n−1)-th frame data and an interpolated (n+1)-th frame data.

8. The method of claim 1, wherein the current frame is an n-th frame, wherein ‘n’ is a natural number, the frame which is adjacent to the current frame in time includes an (n−1)-th frame, and the at least one interpolated frame includes an (n−2)-th frame,
the method further comprises:
calculating a second motion vector using (n−1)-th frame data corresponding to the (n−1)-th frame, and an (n−3)-th frame data interpolated using the first motion vector; and
generating the (n−1)-th frame data and the (n−3)-th frame data interpolated using the second motion vector,
wherein the current frame compensation data is generated using n-th frame data corresponding to the n-th frame, the (n−1)-th frame data, (n−2)-th frame data corresponding to the (n−2)-th frame, and the (n−3)-th frame data.

9. The method of claim 8, further comprising:
compressing the n-th frame data; and
decompressing a compressed (n−1)-th frame data.

10. The method of claim 9, further comprising generating an interpolated (n−1)-th frame data using the first motion vector and second motion vector and the n-th frame data,
wherein the current frame compensation data is generated using the n-th frame data, an interpolated (n−1)-th frame data, an interpolated (n−2)-th frame data and an interpolated (n−3)-th frame data.

11. A display apparatus comprising:
a display panel;
a data processor which generates at least one interpolated frame data using a first motion vector calculated using a plurality of frame data, and generates a current frame compensation data using a current frame data, an adjacent frame data of a frame which is adjacent to a current frame in time and the at least one interpolated frame data;
a data driver which outputs a data voltage corresponding to the current frame compensation data to the display panel; and
a gate driver which outputs a gate signal to the display panel in synchronization with an output of the data voltage.

12. The display apparatus of claim 11, wherein the data processor comprises:
a motion estimating-interpolating part which calculates the first motion vector and generates the at least one interpolated frame data; and
a data compensating part which generates the current frame compensation data using the current frame data, the adjacent frame data and the at least one interpolated frame data.

13. The display apparatus of claim 12, wherein the current frame is an n-th frame, wherein ‘n’ is a natural number, an adjacent frame is an (n−1)-th frame and an interpolated frame is an (n−2)-th frame, and
the first motion vector is calculated using n-th frame data corresponding to the n-th frame and (n−1)-th frame data corresponding to the (n−1)-th frame.

14. The display apparatus of claim 13, wherein the data processor comprises:
a data compressing part which compresses the n-th frame data to be stored in a frame memory; and
a data decompressing part which decompresses compressed (n−1)-th frame data stored in the frame memory.

15. The display apparatus of claim 14, wherein the motion estimating-interpolating part generates an interpolated (n−1)-th frame data using the n-th frame data, and
the data compensating part generates a current frame compensation data using the n-th frame data, the interpolated (n−1)-th frame data and an interpolated (n−2)-th frame data.

16. The display apparatus of claim 12, wherein the current frame is an n-th frame, wherein ‘n’ is a natural number, an adjacent frame is an (n−1)-th frame and an interpolated frame is an (n−2)-th frame, and
the first motion vector is calculated using n-th frame data and (n−1)-th frame data.

17. The display apparatus of claim 16, wherein the data processor further comprises:
a data compressing part which compresses the n-th frame data to be stored in a frame memory; and
a data decompressing part which decompresses compressed (n−1)-th frame data stored in the frame memory.

18. The display apparatus of claim 17, wherein the motion estimating-interpolating part generates an interpolated (n−1)-th frame data using the n-th frame data, and
the data compensating part generates the current frame compensation data using the n-th frame data, an interpolated (n−1)-th frame data and an interpolated (n+1)-th frame data.

19. The display apparatus of claim 16, wherein the current frame is an n-th frame, an adjacent frame is an (n−1)-th frame, and an interpolated frame is an (n−2)-th frame,
the motion estimating-interpolating part generates a second motion vector using the (n−1)-th frame data and interpolated (n−3)-th frame data interpolated using the first motion vector, and generates the interpolated (n−3)-th frame data using the (n−1)-th frame data and the second motion vector, and
the data compensating part generates the current frame compensation data using the n-th frame data, the (n−1)-th frame data, (n−2)-th frame data and (n−3)-th frame data.

20. The display apparatus of claim 19, wherein the data processor further comprises:
a data compressing part which compresses the n-th frame data to be stored in a frame memory; and
a data decompressing part which decompresses compressed (n−1)-th frame data stored in the frame memory.
